(19) United States
(12) Patent Application Publication
(10) Pub. No.: US 2021/0376872 A1
(43) Pub. Date: Dec. 2, 2021

(54) PROTECTIVE CASE FOR MOBILE ELECTRONIC DEVICE WITH REMOVABLE CAMERA RING INSERT

(71) Applicant: Incipio, LLC, Irvine, CA (US)

(72) Inventors: Andy T. Le, Cerritos, CA (US); Vincent Chiangtong, Huntington Beach, CA (US); Kenji H. Okada, Anaheim, CA (US); Cody A. Brooner, Laguna Niguel, CA (US)

(73) Assignee: Incipio, LLC, Irvine, CA (US)

(21) Appl. No.: 17/337,406

(22) Filed: Jun. 2, 2021

Related U.S. Application Data
(60) Provisional application No. 63/033,528, filed on Jun. 2, 2020.

(51) Int. Cl. H04B 1/3888; H04M 1/02

(52) U.S. Cl. CPC H04B 1/3888; H04M 1/0264

(57) ABSTRACT

A camera ring insert for use with a protective case for a mobile device is disclosed herein. The camera ring insert is configured to be inserted into a camera lens opening of the protective case by attaching the outer edge surface of the camera ring insert to the inner edge surface of the camera lens opening. The outer edge surface of the camera ring insert may include a securing portion and the inner edge surface of the camera lens opening may also include a securing portion that is configured to reversibly engage the securing portion of the camera ring insert to lock the camera ring insert into its inserted position.

### CROSS REFERENCE TO RELATED APPLICATIONS

This application claims the benefit of and priority to U.S. Provisional Patent Application Ser. No. 63/033,528, filed on Jun. 2, 2020, the entirety of which is hereby incorporated herein by reference.

thicker or thinner

### BACKGROUND

### Field of the Invention

The present disclosure relates to protective cases for mobile electronic devices.

### Description of the Related Art

Mobile electronic devices, such as smartphones, tablets, laptops, and the like are known to sustain damage from impact and from contamination as a result of the ingress of water or other fluids. Such damage may result, for example, in a cracked screen, scratches on a finished surface, lost or damaged buttons or controls, cracked or bent external body components, and/or failed or malfunctioning electrical components. Protective cases can protect mobile electronic devices from such damage and other types of damage.

Mobile electronic device technology is rapidly evolving, and manufacturers release new versions of mobile electronic devices on a frequent basis. Users seeking to upgrade a mobile electronic device to a newer model typically also have to upgrade the protective case associated with the device, as the dimensions of the new mobile electronic device and the size and location of various openings, such as openings for the camera, charging port, volume buttons, power button, and other features, often differ between the various models of a mobile electronic device.

Accordingly, there remains a need for a protective case for a mobile electronic device with features to ensure compatibility of the protective case with multiple mobile electronic devices or multiple models of a particular manufacturer's mobile electronic devices.

### SUMMARY

A protective case that is configured to receive, retain, and protect a mobile electronic device is disclosed herein. The mobile electronic device has a front face and a back face that define the height of the mobile electronic device, a perimeter defined by a top, bottom, left, and right sides residing between the front and back faces, and corners defined at the intersecting regions of the faces and sides. The mobile electronic device may have one or more touchscreens and also has one or more inputs on its front face, back face, and/or its sides. These inputs include a camera lens window on the back face of the mobile electronic device. The inputs may also include a charging port, volume buttons, power button, and other features.

The protective case may include a front face wall and an opposing back face wall, and top, bottom, left, and right side walls. Each of the front face wall, back face wall, and top, bottom, left, and right side walls has an inner surface and an outer surface that are parallel or substantially parallel, and also has a thickness that is defined as the shortest distance along a line orthogonal to the outer surface in the direction of the inner surface. The front face wall, back face wall, and top, bottom, right, and let side walls are dimensioned such that the protective case is configured to receive and retain a mobile electronic device. The front face wall includes an aperture that has nearly the same dimensions as but is slightly smaller than the front face of the mobile electronic device that it is configured to retain, such that a mobile electronic device may be readily inserted into or removed from the case and also may be properly retained and secured within the case after it is inserted into the case.

The protective case may be generally configured according to a previously disclosed configuration and structure, such as the protective cases disclosed in U.S. Pat. Nos. 8,800,762, 9,281,858, and 10,236,928. Alternatively, the protective case may be configured according to a configuration that has not been previously described.

The back face wall of the protective case includes a camera lens opening that extends through the back face wall and is configured to extend around the outside of the camera lens window on the back face of the mobile device. The camera lens opening has an inner edge surface along its thickness. The protective case further includes a removable camera ring insert that is dimensioned to cover a portion, but not all, of the camera lens opening. The camera ring insert has an inner surface and an outer surface that are parallel or substantially parallel, and also has a thickness that is defined as the shortest distance along a line orthogonal to the outer surface in the direction of the inner surface. The camera ring insert has an outer edge surface along its thickness.

The camera ring insert is configured to be inserted into the camera lens opening. The camera ring insert preferably has the same thickness as the back face wall, such that the outer surface of the back face wall and outer surface of the camera ring insert are flush when the camera ring insert is inserted into the camera lens opening. In alternate embodiments, the camera ring insert has a thickness that is less than the thickness of the back face wall. In other alternate embodiments, the camera ring insert has a thickness that is more than the thickness of the back face wall.

The camera ring insert may be inserted into the camera lens opening by attaching the outer edge surface of the camera ring insert to the inner edge surface of the camera lens opening. The outer edge surface of the camera ring insert may include a first securing portion and the inner edge surface of the camera lens opening may include a second securing portion that is configured to reversibly engage the first securing portion of the camera ring insert to lock the camera ring insert into its inserted position. The first securing portion and second securing portion may together form a securing system.

In some embodiments, the first securing portion and second securing portion may securely mate together to secure the camera ring insert into the camera lens opening. In some other embodiments, the securing system may require physical engagement or disengagement of the first securing portion with the second securing portion, such as by turning, snapping, or other physical manipulation of the first securing portion, the second securing portion, or both.

In some embodiments, the securing system may be a snap lock system. In alternate embodiments, the securing system may include tabs, rotational locks, or clips.

The disclosed camera ring insert is particularly suitable for use with families of mobile electronic devices that have substantially the same overall dimensions and within which the locations of charging port, volume buttons, power button, and other features other than the camera lens window are the same. This applies, for example, for the family of mobile electronic devices made by Apple®, Inc. that includes the following groupings of mobile electronic devices: the iPhone® XR and iPhone® 11, the iPhone® X, iPhone® XS, and iPhone® 11 Pro, and the iPhone® XS Max and iPhone® 11 Pro Max, respectively. Each of these pairs of mobile electronic devices has the same overall dimensions and the locations of the charging port, volume buttons, and power button as the other device in the pair, and each of the devices within each pair differ only in the dimensions of the camera lens window.

Each of the foregoing and various aspects, together with those set forth below and summarized above or otherwise disclosed herein, including the figures, may be combined without limitation to form claims for a device, apparatus, system, method of manufacture, and/or method of use.

### BRIEF DESCRIPTION OF THE DRAWINGS

The figures provided herewith are intended to illustrate but not to limit the invention. Like reference characters in the figures denote corresponding features consistently throughout similar embodiments.

FIG. 1 shows a rear angled view of an embodiment of the protective case with the camera ring insert inserted into the camera lens opening.

FIG. 2 shows the embodiment of FIG. 1 with the camera ring insert not inserted into the camera lens opening.

FIG. 3 shows the embodiment of FIG. 1 with the camera ring insert positioned above the camera lens opening and illustrates how the camera ring insert is inserted into the camera lens opening.

FIG. 4 shows a back face view of the embodiment of FIG. 1.

FIG. 5 shows a cutout of a side view of a part of the embodiment of FIG. 1 with the camera ring insert not inserted into the camera lens opening.

FIG. 6 shows a cutout of a side view of a part of the embodiment of FIG. 1 with the camera ring insert inserted into the camera lens opening.

### DETAILED DESCRIPTION OF THE ILLUSTRATED EMBODIMENTS

A protective case that is configured to receive, retain, and protect a mobile electronic device is disclosed herein. The mobile electronic device has a front face and a back face that define the height of the mobile electronic device, a perimeter defined by a top, bottom, left, and right sides residing between the front and back faces, and corners defined at the intersecting regions of the faces and sides. The mobile electronic device may have one or more touchscreens and also has one or more inputs on its front face, back face, and/or its sides. These inputs include a camera lens window on the back face of the mobile electronic device. The inputs may also include a charging port, volume buttons, power button, and other features.

The protective case may include a front face wall and an opposing back face wall, and top, bottom, left, and right side walls. Each of the front face wall, back face wall, and top, bottom, left, and right side walls has an inner surface and an outer surface that are parallel or substantially parallel, and also has a thickness that is defined as the shortest distance along a line orthogonal to the outer surface in the direction of the inner surface. The front face wall, back face wall, and top, bottom, right, and left side walls are dimensioned such that the protective case is configured to receive and retain a mobile electronic device. The front face wall includes an aperture that has nearly the same dimensions as but is slightly smaller than the front face of the mobile electronic device that it is configured to retain, such that a mobile electronic device may be readily inserted into or removed from the case and also may be properly retained and secured within the case after it is inserted into the case.

The protective case may be generally configured according to a previously disclosed configuration and structure, such as the protective cases disclosed in U.S. Pat. Nos. 8,800,762, 9,281,858, and 10,236,928. Alternatively, the protective case may be configured according to a configuration that has not been previously described.

The back face wall of the protective case includes a camera lens opening that extends through the back face wall and is configured to extend around the outside of the camera lens window on the back face of the mobile device. The camera lens opening has an inner edge surface along its thickness. The protective case further includes a removable camera ring insert that is dimensioned to cover a portion, but not all, of the camera lens opening. The camera ring insert has an inner surface and an outer surface that are parallel or substantially parallel, and also has a thickness that is defined as the shortest distance along a line orthogonal to the outer surface in the direction of the inner surface. The camera ring insert has an outer edge surface along its thickness.

The camera ring insert is configured to be inserted into the camera lens opening. The camera ring insert preferably has the same thickness as the back face wall, such that the outer surface of the back face wall and outer surface of the camera ring insert are flush when the camera ring insert is inserted into the camera lens opening. As used herein, the phrase “the same thickness” means approximately the same thickness such that any differences in thickness would not be readily noticeable to an ordinary user of the protective case without close inspection. In alternate embodiments, the camera ring insert has a thickness that is less than the thickness of the back face wall. In other alternate embodiments, the camera ring insert has a thickness that is more than the thickness of the back face wall.

The camera ring insert may be inserted into the camera lens opening by attaching the outer edge surface of the camera ring insert to the inner edge surface of the camera lens opening. The outer edge surface of the camera ring insert may include a first securing portion and the inner edge surface of the camera lens opening may include a second securing portion that is configured to reversibly engage the first securing portion of the camera ring insert to lock the camera ring insert into its inserted position. The first securing portion and second securing portion may together form a securing system.

In some embodiments, the first securing portion and second securing portion may securely mate together to secure the camera ring insert into the camera lens opening. In some other embodiments, the securing system may require physical engagement or disengagement of the first securing portion with the second securing portion, such as by turning, snapping, or other physical manipulation of the first securing portion, the second securing portion, or both.

In some embodiments, the securing system may be a snap lock system. In alternate embodiments, the securing system may include tabs, rotational locks, or clips.

The disclosed camera ring insert is particularly suitable for use with families of mobile electronic devices that have substantially the same overall dimensions and within which the locations of charging port, volume buttons, power button, and other features other than the camera lens window are the same. This applies, for example, for the family of mobile electronic devices made by Apple®, Inc. that includes the following groupings of mobile electronic devices: the iPhone® XR and iPhone® 11, the iPhone® X, iPhone® XS, and iPhone® 11 Pro, and the iPhone® XS Max and iPhone® 11 Pro Max, respectively. Each of these pairs of mobile electronic devices has the same overall dimensions and the locations of the charging port, volume buttons, and power button as the other device in the pair, and each of the devices within each pair differ only in the dimensions of the camera lens window.

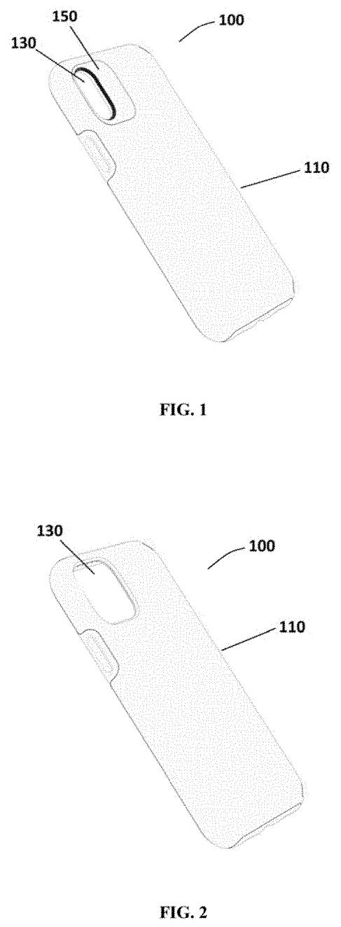

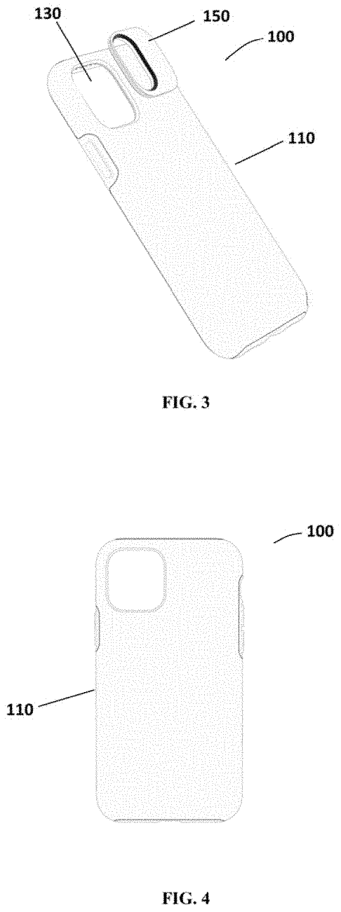

FIG. 1 shows a rear angled view of an embodiment 100 of the protective case with a camera ring insert 150 inserted into a camera lens opening 130 in the main body 110 of the case. FIG. 2 shows the embodiment of FIG. 1 without the camera ring insert. FIG. 3 shows the embodiment of FIG. 1 with the camera ring insert 150 positioned above the camera lens opening 130 and illustrates how the camera ring insert 150 is inserted into the camera lens opening 130. FIG. 4 shows a back face view of the embodiment of FIG. 1.

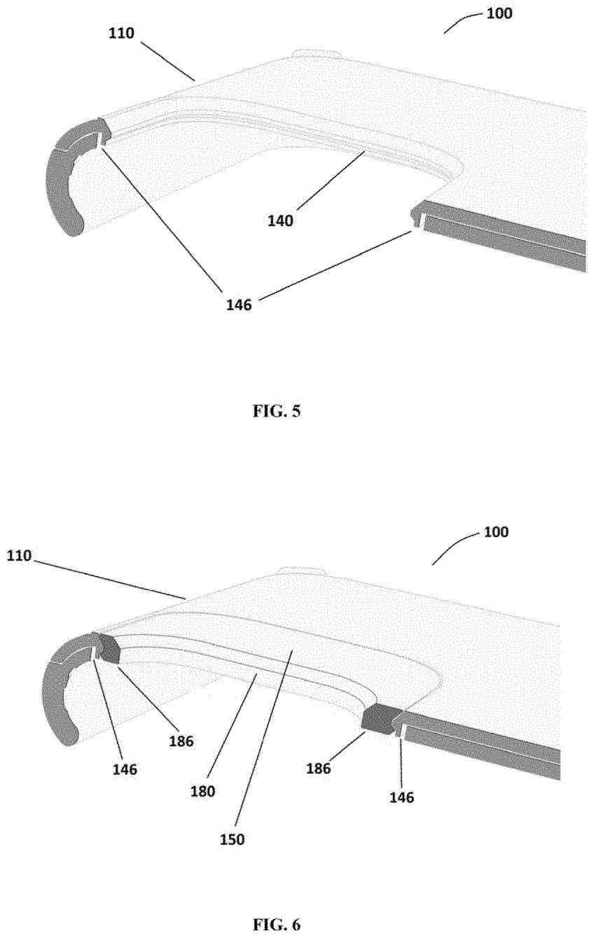

FIG. 5 shows a cutout of a side view of a part of the embodiment of FIG. 1 without the camera ring insert. Second securing portions 146 are positioned on each side of the inner edge surface 140 of the camera lens opening.

FIG. 6 shows a cutout of a side view of a part of the embodiment of FIG. 1 with the camera ring insert 150 inserted into the camera lens opening. First securing portions 186 are positioned on each side of the outer edge surface 180 of the camera ring insert 150. The first securing portions 186 are positioned to be reversibly engaged with the second securing portions 146. The first securing portions and second securing portions together form a securing system, which may be a snap lock system.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Each of the foregoing and various aspects, together with those summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A protective case system for a mobile device comprising:
a protective case that is configured to reversibly receive a mobile device; and
a removable camera ring insert;
wherein the protective case has a front face wall and an opposing back face wall, and top, bottom, left, and right side walls, wherein each of the front face wall, back face wall, and top, bottom, left, and right side walls has an inner surface and an outer surface that are parallel or substantially parallel,
wherein each of the front face wall, back face wall, and top, bottom, left, and right side walls has a thickness that is defined as the shortest distance along a line orthogonal to the outer surface in the direction of the inner surface,
wherein the front face wall, back face wall, and top, bottom, right, and left side walls are dimensioned such that the protective case is configured to receive and retain a mobile electronic device,
wherein the front face wall includes an aperture that has nearly the same dimensions as but is slightly smaller than the front face of the mobile electronic device that it is configured to retain, such that a mobile electronic device may be readily inserted into or removed from the case and also may be properly retained and secured within the case after it is inserted into the case,
wherein the back face wall has a camera lens opening that extends through the back face wall and is configured to extend around the outside of a camera lens window on the back face of the mobile device,
wherein the camera lens opening has an inner edge surface along its thickness,
wherein the camera ring insert is dimensioned to cover a portion, but not all, of the camera lens opening and is configured to be inserted into the camera lens opening,
wherein camera ring insert has an inner surface and an outer surface that are parallel or substantially parallel, and also has a thickness that is defined as the shortest distance along a line orthogonal to the outer surface in the direction of the inner surface,
wherein the camera ring insert has an outer edge surface along its thickness, and
wherein the camera ring insert is inserted into the camera lens opening by attaching the outer edge surface of the camera ring insert to the inner edge surface of the camera lens opening.

2. The protective case system of claim 1, wherein the outer edge surface of the camera ring insert includes a first securing portion and the inner edge surface of the camera lens opening includes a second securing portion that is configured to reversibly engage the first securing portion to lock the camera ring insert into its inserted position.

3. The protective case system of claim 2, wherein the first securing portion and second securing portion form a securing system.

4. The protective case system of claim 3, wherein the securing system is a snap lock system.

5. The protective case system of claim 3, wherein the securing system has tab locks.

6. The protective case system of claim 3, wherein the securing system is a rotational lock system.

7. The protective case system of claim 3, wherein the securing system has clips.

8. The protective case system of claim 2, wherein the camera ring insert and the back face wall have the same thickness.

9. The protective case system of claim 4, wherein the camera ring insert and the back face wall have the same thickness.
